(19) United States
(12) Patent Application Publication
(10) Pub. No.: US 2006/0177670 A1
(43) Pub. Date: Aug. 10, 2006

(54) Coating and method for coating a zinc-containing substrate

(76) Inventors: Mohan Sanduja, Flushing, NY (US); Sundershan Sanduja, Sugar Land, TX (US); Carl Horowitz, Phoenix, AZ (US); Ella Mayslich, Brooklyn, NY (US); Paul Thottathil, New Hyde Park, NY (US)

Correspondence Address: KENYON & KENYON LLP, 1500 K STREET N.W., SUITE 700, WASHINGTON, DC, 20005, US

(21) Appl. No.: 11/297,564

(22) Filed: Dec. 9, 2005

Related U.S. Application Data
(63) Continuation-in-part of application No. 10/607,254, filed on Jun. 25, 2003, now abandoned.

(51) Int. Cl. H01M 10/44; B32B 27/00

(52) U.S. Cl. 428/425.8; 205/64; 205/317

(57) ABSTRACT

A composition and method for coating a zinc-containing substrate. The composition and method provide a film that is chemically grafted onto the zinc-containing substrate, that is anticorrosive and abrasion resistant, and can be applied as a clear film and is capable of providing an appearance that can mimic various finishes such as chrome, gold, brass, satin chrome, and the like.

### CROSS REFERENCE TO RELATED APPLICATIONS

This application claims priority to application Ser. No. 10/607,254, filed Jun. 25, 2003, pending, the contents of which are expressly incorporated herein.

### FIELD OF INVENTION

The present invention relates to composition and method for coating a zinc-containing substrate. The composition and method provide a film that is chemically grafted onto the zinc-containing substrate, that is anticorrosive and abrasion resistant, and can be applied as a clear film and is capable of providing an appearance that can mimic various finishes such as chrome, gold, brass, satin chrome, and the like.

### BACKGROUND TO THE INVENTION

There are many different types of finishes that can be applied to a substrate. Some finishes are purely decorative while others are applied to attain certain performance standards. Finishes can be physically or chemically bonded to the surface of a substrate. Chemical bonds are much stronger than physical bonds, and chemically bonded finishes have a lower tendency to be removed by abrasion and wear. Chemically bonding polymeric materials to a substrate is known as chemical grafting, as described in U.S. Pat. Nos. 5,232,748 and 3,401,049. These patents describe grafting a polymeric finish onto non-metallic substrates in steps that include pre-activating the substrate and applying a polymeric coating. These patents describe using heat, lasers and microwaves to accelerate the polymerization and cure the coating.

For zinc in particular, there are several types of finishes. If unprotected, zinc-containing substrates tarnish quickly, adversely affecting appearance. Conventionally, in order for finishes to protect zinc-containing substrates and achieve specified decorative colors, methods like electroplating; physical vapor deposition (PVD); or painting with coatings such as epoxy, lacquer, enamel, or acrylic are used.

In electroplating, a metal is deposited on the surface of an article by placing the article to be plated in a bath containing a metallic salt solution, such as a nickel or chrome salt solution, and the article is negatively charged. Through the ionization of the metal salt in the bath, a physical bond is formed between the metal and the article to be plated. There are several problems, however, with electroplating. Often the article must undergo expensive buffing or polishing before the electroplating process in order to achieve the desired appearance. Most conventional finishing methods require some type of pre-sealing step before a conventional finish can be applied to zinc, such as applying a protective layer of copper, called a copper strike, to protect the surface of the zinc-containing substrate from subsequent acid solutions. After the copper strike is applied, the surface can then be coated with a layer of nickel followed by a layer of chrome using known technologies. The differences between the metal in the plating and the metal in the substrate can lead to corrosion, and minute defects in the chrome plating can lead to white rust and corrosion blisters. Moisture on the plated coating can lead to corrosion of the substrate. Also, because electroplating attaches a coating to a substrate by a physical bond, the coatings are susceptible to removal by abrasion when used by consumers. Furthermore, known chrome plating processes require the use of chemicals like hexavalent chrome and cyanide solutions, which are extremely toxic, known carcinogens, and highly regulated. The zinc-containing substrates must also undergo an extensive cleaning process before plating can even begin.

PVD is a technique that uses various power sources like lasers or sputtering to form a vapor of a material to be deposited on an article as a thin film. As described in U.S. Pat. No. 6,245,435, PVD methods can achieve specific decorative colors such as gray, gold, or black, but are conventionally used to obtain a hard clear finish on a substrate. Without the need for the same toxic chemicals, PVD by itself can be more environmentally friendly than electroplating. To prevent corrosion on zinc, a current practice is to electroplate the zinc-containing substrate with an anti-corrosive material before depositing an outer coating by PVD. This step, however, introduces many of the environmental problems encountered in electroplating. In the case of decorative coatings, which are generally soft and have little resistance to abrasion or corrosion, a substrate will have to be coated with a layer of protective materials as well as the layer of decorative materials in order to be made corrosion and abrasion resistant. PVD also requires that the surface of the substrate be free from defects.

PVD poses a special problem for zinc die-castings. The heat and pressure used in PVD can lead to trapped gas in voids beneath the PVD applied coating. The gas can then work its way through the protective layers, creating a pathway to corrosion. Another disadvantage of PVD methods is that process requires the coating to be done in small batches that, coupled with the specialized equipment and the huge amount of scrap and waste produced, makes the process prohibitively expensive.

For painted coatings, specific decorative colors may be achieved along with specified surface characteristics like corrosion protection. Coating thickness, however, must be stringently controlled and the coating only involves a physical bond. Such a coating can be removed by abrasion.

Thus, there exists a need for improved compositions and methods for coating zinc-containing substrates. Specifically, there is a need for compositions and methods that provide a chemically bonded coating on a zinc-containing substrate that can deliver specific decorative colors and meet or exceed industry standard for corrosion, abrasion, humidity, and blistering. Preferably, the finish is applicable in one step and the process does not entail the expense or environmental problems associated with conventional methods

### SUMMARY OF THE INVENTION

The invention relates to a composition useful for providing a protective film on a zinc-containing substrate. The composition comprises:
(i) an alkenyl monomer;
(ii) a pre-polymer; and
(iii) a graft initiator,
   wherein applying the composition to a zinc containing substrate provides a film on the zinc-containing substrate that is chemically grafted to the zinc-containing substrate.

The invention further relates to a coating composition comprising the composition useful for providing a protective film on a zinc-containing substrate and a solvent.

The invention further relates to a method for forming a protective film on a zinc-containing substrate. The method involves the steps of:
(a) providing a zinc-containing substrate;
(b) providing a coating solution comprising
   (i) an alkenyl monomer;
   (ii) a pre-polymer; and
   (iii) a graft initiator, and
(c) contacting the zinc-containing substrate with the coating solution
   wherein applying the composition to the zinc containing substrate provides a film on the zinc-containing substrate that is chemically grafted to the zinc-containing substrate.

The invention further relates to an article of manufacture comprising:

a zinc-containing substrate and a film chemically bonded to the zinc-containing substrate, wherein the film is formed by contacting the zinc-containing substrate with a coating solution comprising
(i) an alkenyl monomer;
(ii) a pre-polymer; and
(iii) a graft initiator.

### DESCRIPTION OF THE PREFERRED EMBODIMENTS

The present invention is directed to a composition for use as coating for a zinc containing substrate. The composition comprises:
(i) an alkenyl monomer;
(ii) a pre-polymer; and
(iii) a graft initiator,
   wherein applying the composition to a zinc containing substrate provides a film on the zinc-containing substrate that is chemically grafted to the zinc-containing substrate.

The invention also relates to a method for coating a zinc containing substrate comprising providing a zinc containing substrate and contacting the zinc containing substrate with a composition comprising:
(i) an alkenyl monomer;
(ii) a pre-polymer;
(ii) a graft initiator,
   wherein applying the composition to the zinc containing substrate provides a film on the zinc-containing substrate that is chemically grafted to the zinc-containing substrate.

The term “alkenyl monomer,” as used herein means a compound of formula C(R₁)(R₂)═C(R₃)(R₄). R₁, R₂, R₃, and R₄ are each hydrogen, a hydrocarbon chain, or a functional group, however, at least one of R₁-R₄ is a hydrocarbon group or functional group. In one embodiment, at least one of R₁-R₄ is a hydrocarbon group and the hydrocarbon group is substituted with one or more functional groups X. Representative functional groups, X, include, but are not limited to, hydroxyl groups, alkenyl groups, alkynyl groups, carboxyl groups (for example, aldehydes and ketones), ester groups, ether groups, amine groups, epoxide groups, glycidyl groups, and siloxane groups (i.e., —Si(OR₅)(OR₆)(OR₇) or —Si(R₅)(R₆)(R₇), wherein R₅-R₇ are each independently a hydrocarbon group optionally substituted with one or more functional groups X). In one embodiment, R₅-R₇ are each independently a hydrocarbon group having between 1 and 6 carbon atoms. In one embodiment, at least one of R₁-R₄ is a hydrocarbon group substituted with a hydroxyl group. In one embodiment, the alkenyl monomer is CH₂═CHR₁, wherein R₁ is a hydrocarbon group substituted with X. In one embodiment, the alkenyl monomer is CH₂═CH—CH₂X. In one embodiment, X is a siloxane group.

The term “hydrocarbon group,” as used herein means a straight or branched, saturated or unsaturated, cyclic or non-cyclic, aromatic or non-aromatic, carbocyclic group. Typically, a hydrocarbon group has from about 1 to 22 carbon atoms.

In one embodiment, the alkenyl monomer has a molecular weight less than about 1,000 g/mol, preferably less than about 750 g/mol, and more preferably less than about 500 g/mol.

Representative alkenyl monomers include, but are not limited to vinyl alcohol; divinylbenzene; vinyl toluene; acrylic acid (preferably acrylic acid esters wherein the ester chain is greater than 10 carbons, more preferably greater than 14 carbons); methacrylic acid (preferably acrylic acid esters wherein the ester chain is greater than 10 carbons, more preferably greater than 14 carbons); and substituted acrylic acid or methacrylic acid monomers (such as hydroxyethylacrylate, hydroxymethylmonoacrylate, and hydroxypropylacrylate).

In one embodiment, the alkenyl monomer includes an ester functional group and at least one carbon-carbon double bond, i.e., the alkenyl monomer has the general formula R₁₀—C(O)—OR₁₁, wherein R₁₀ and R₁₁ are hydrocarbon groups and at least one of R₁₀ or R₁₁ includes a carbon-carbon double bond. The alkenyl monomer can be further substituted with a functional group X. Either R₁₀ or R₁₁ can be substituted with a functional group X. The functional group X can be any of the functional groups described above.

In one embodiment, the alkenyl monomer has the structure 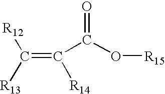
wherein R₁₂, R₁₃, R₁₄, are each hydrogen or a hydrocarbon chain and R₁₅ is a hydrocarbon chain. In one embodiment, at least one of R₁₂-R₁₄ is a hydrocarbon group. In one embodiment, one or more hydrocarbon groups are substituted with one or more functional groups X. The functional group X can be any of the functional groups described above. In one embodiment, the hydrocarbon chain R₁₅ of the pre-polymer has at least about 14 carbon atoms.

In one embodiment, the alkenyl monomer is

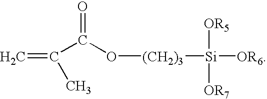

In one embodiment, the alkenyl monomer is gamma methacyloxypropyltrimethoxy-silane, i.e.,

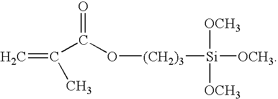

Representative commercially available alkenyl monomers include, but are not limited to, substituted acrylic acid and methacrylic acid monomers (commercially available from Sartomer Company of Exton, Pa.), the silicon containing alkenyl monomers commercially available from GE Silicones (of South Charleston, W.Va.) or OSI Specialties (of Danbury, Conn.). In one embodiment, the alkenyl monomer is Silquest A174 (commercially available from OSI to Specialties of Danbury, Conn.).

In one embodiment, a combination of alkenyl monomers are included in the composition.

The term “pre-polymer,” as used herein, means a polymeric chain formed by the partial polymerization of more than one monomer molecule to provide a polymer chain that still includes a functional group, such as a carbon-carbon double bond or epoxide group, so that the is polymer chain can undergo further free radical polymerization. Generally, the molecular weight of the pre-polymer is higher than the molecular weight of the monomer. In one embodiment, the pre-polymer has a molecular weight greater than about 500 g/mol. In one embodiment, the pre-polymer has a molecular weight greater than about 1,000 g/mol. In one embodiment, the pre-polymer has a molecular weight greater than about 1,500 g/mol. In one embodiment, the pre-polymer has a molecular weight greater than about 2,000 g/mol. In one embodiment, the molecular weight of the pre-polymer is less than about 20,000 g/mol. In one embodiment, the molecular weight of the pre-polymer is less than about 15,000 g/mol. In one embodiment, the molecular weight of the pre-polymer is less than about 10,000 g/mol.

Representative pre-polymers include, but are not limited to, pre-polymers formed from any of the alkenyl monomers described above. In one embodiment, the pre-polymer is a mixture of siloxane polyalkyleneoxide copolymer and polyalkylene oxide. In one embodiment, the pre-polymer is a mixture of organoodified polydimethylsiloxane and polyalkylene glycol.

Representative commercially available pre-polymers include, but are not limited to, Chempol 206-94 and Chempol 011-2339 (each commercially available Cook Composites and Polymers of Kansas, Mo.); the Silikoftal resins, such as Silikoftal RTL, Silikoftal HTL2, and Silikoftal HTS (each commercially available from DeGussa Tego Coating and Ink of Hopewell, Va.); and Beckosol 1700-M-60 (commercially available from Reichliold Co. of Durham, N.C.).

In one embodiment, a combination of pre-polymers are included in the composition.

In one embodiment, the alkenyl monomer and the pre-polymer do not include isocyanate groups.

The graft initiator is a compound that causes the alkenyl monomer and/or the pre-polymer to become chemically grafted to the zinc containing substrate. Representative graft initiators include, but are not limited to, salts of Ag⁺, Fe⁺³, Co⁺², and Cu⁺². Preferably, the graft initiator is a silver ion graft initiator (i.e., a graft initiator that includes silver ion in its chemical formula). A preferred graft initiator is silver perchlorate (AgClO₄).

The phrase “chemically grafted,” as used herein, means that a compound is attached to a surface by a chemical bond. For example, the phrase “the alkenyl monomer and/or the pre-polymer is chemically grafted to the zinc containing substrate” means that the alkenyl monomer or pre-polymer is bonded to the zinc containing substrate by a chemical bond. A coating that is chemically grafted to a surface is distinguished from a coating that is physically grafted to the surface, i.e., wherein the coating merely sits on the surface of the substrate and interacts with the surface of the substrate by interactions other than chemical bonds.

Typically, the composition i.e., the alkenyl monomer, pre-polymer, and graft initiator is combined with a solvent to provide a coating solution. Preferably, the components of the composition are dissolved in the solvent. Representative solvents useful in the compositions and methods of the invention include, but are not limited to, methyl ethyl ketone, propylene glycol monomethyl ether acetate (PM acetate), acetone, methyl amyl ketone (MAK), and methyl isobutyl ketone (MIBK).

Typically, the alkenyl monomer is present in the coating solution in an amount ranging from about 0.2-10 percent by weight of the composition, preferably about 0.25-7.5 percent by weight of the composition, and more preferably about 0.5-6.3 percent by weight of the coating solution. In one embodiment, the alkenyl monomer is present in the coating solution in an amount ranging from about 0.2-6.3 percent by weight of the composition.

Typically, the pre-polymer is present in the coating solution in an amount ranging from about 2-80 percent by weight of the coating solution, preferably about 3-70 percent by weight of the coating solution, and more preferably about 4.6-63 percent by weight of the coating solution. In one embodiment, the pre-polymer is present in the coating solution in an amount ranging from about 4.6-70 percent by weight of the coating solution.

Typically, the graft initiator is present in the coating solution in an amount ranging from about 0.5×10⁻⁵ to 3×10⁻⁴ percent by weight of the coating solution. In one embodiment, the graft initiator is present in the coating solution in an amount ranging from about 1×10⁻⁵ to 3×10⁻⁴ percent by weight of the coating solution. In one embodiment, the graft initiator is present in the coating solution in an amount ranging from about 4×10⁻⁵ to 2.5×10⁻⁴ percent by weight of the coating solution. In one embodiment, the graft initiator is present in the coating solution in an amount ranging from about 5×10⁻⁵ to 2×10⁻⁴ percent by weight of the coating solution. In one embodiment, the graft initiator is present in the coating solution in an amount ranging from about 6×10⁻⁵ to 1.7×10⁻⁴ percent by weight of the coating solution.

The zinc-containing substrate should contain more than a trace amount of zinc, i.e., at least about 10%, preferably at least about 25%, more preferably at least about 50%, and most preferably at least about 70% by weight of the zinc-containing substrate. The zinc-containing substrate can be a zinc-die cast, a galvanized zinc-coated surface, or other zinc-containing article.

The compositions are prepared by simply combining the components of the invention together. Typically, the components are combined by individually adding the components to the solvent, preferably with stirring, to provide the coating solution. Typically, the graft initiator is added last. In one embodiment, the components are mixed and then stored in a 55-gallon drum. In one embodiment, the components of the composition are added in the order described in the examples. Typically, the coating is not mixed far in advance of being used to coat a zinc-containing substrate. The shelf life of the coating solution is typically about 90 days. Storage in a sealed container minimizes degradation and helps extend shelf life.

The invention is also directed to a method of coating a zinc-containing substrate to to provide a protective film on the zinc-containing substrate. The method involves contacting the zinc-containing substrate with the composition of the invention, typically as a coating solution. The contacting can be by any means known to those skilled in the art. The zinc-containing substrate should be oil and dust free before the coating is applied. In one embodiment, the zinc-containing substrate is washed, for example using a mixture that contains soapy water, deionized water or other appropriate solution, prior to being contacted with the coating solution. In one embodiment, the zinc-containing substrate and wash mixture are contacted and subject to ultrasound to further clean the zinc-containing substrate. After the wash, the zinc-containing substrate is dried, for example by air-drying. In one embodiment, the zinc-containing substrate is buffed and polished prior to being contacted with the coating solution.

The coating solution can be applied by dipping, spraying, or any other conventional application method. In one embodiment, the coating solution is applied by atomizing the coating solution using compressed air to spray the coating solution onto the zinc-containing substrate. In one embodiment, the zinc-containing substrate is electrostatically charged to promote good spray coverage on the zinc-containing substrate. A rack, conveyor system, or other conventional means can be used to hold the zinc-containing substrate in place during the coating process. The rack may also be electrostatically charged to promote good spray coverage.

In one embodiment, the coating solution can further comprises one or more additional additives to facilitate application of the coating solution to the zinc-containing substrate (for example, to improve wettability or air release of the coating solution) and/or to modify the properties of the resulting film (for example, to improve water resistance, abrasion resistance, or mar resistance of the film). A representative additive, useful in the coating solutions of the invention include, but are not limited to, the silicon polyether copolymers such as Coatosil 1211 and Coatosil 3573 (each commercially available from GE Advanced Materials of Fairfield Conn.).

In one embodiment, a defoaming or leveling agents is added to the coating solution to facilitate application of the coating solution. Any, defoaming or leveling agents known to those skilled in the art can be used. Representative defoaming agents include, but are not limited to, those commercially available from BYK Chemie (a division of Altana Chemie, of Germany), DeGussa Tego Coating and Ink (of Hopewell Va.), and Crompton Manufacturing Company (a Chemtura Corporation, of Middlebury Conn.). Typically, the defoaming agent is present in an amount ranging from about 0.05 to 0.5 percent by weight of the coating solution, preferably about 0.1 to 0.3 percent by weight of the coating solution.

After the zinc-containing substrate is contacted with the coating solution, the coating solution is dried. During drying, moisture and solvents are evaporated from the film. The zinc-containing substrate may also be cured. The term “cured,” as used herein, means that the alkenyl monomers and pre-polymers undergo chemical reactions such as, but not limited to, polymerization to form a polymer and cross-linking of the resulting polymer. Typically, during curing the reactive sites on the alkenyl monomer and/or pre-polymer (i.e., the functional groups on the alkenyl monomer and pre-polymer that are involved in polymerization are fully reacted so that no further polymerization can take place). While drying and curing can take place at room temperature, the drying can be accelerated with heat.

In one embodiment, the coating solution is air dried without heat.

In one embodiment, heat is used to accelerate the drying process.

In one embodiment, the drying and curing take place at a temperature greater than about 300° F. In one embodiment, the drying and curing take place at a temperature greater than about 350° F. In one embodiment, the drying and curing take place at a temperature greater than about 400° F. In one embodiment, the drying and curing take place at a temperature greater than about 425° F. Although, the drying temperature and the drying time will vary depending on the composition of the coating solution, generally, the higher the temperature the shorter the drying time. In one embodiment, the zinc-containing substrate is dried for about 1 to 3 minutes and cured for about 10 to 12 minutes at about 300-350° F. After drying and curing, the zinc-containing substrate is cooled. When the coating solution is applied by spraying and the zinc-containing substrate is dried for about 1 to 3 minutes and cured for about 10 to 12 minutes at about 300-350° F., the entire process takes only about 20 to 30 minutes.

In one embodiment, the coating solution further comprises a small amount of catalyst, preferably a peroxide (such as benzoyl peroxide or methyl ethyl ketone peroxide). Without wishing to be bound by theory, it is believed that the catalyst accelerates the polymerization reaction leading to the film by regenerating the graft initiator and providing more reactive free radicals. Typically, the catalyst is present in an amount ranging from about 0.5×10⁻⁶ to 3×10⁻⁴ percent by weight of the coating solution. In one embodiment, the catalyst is present in the coating solution in an amount ranging from about 1×10⁻⁶ to 3×10⁻⁴ percent by weight of the coating solution. In one embodiment, the catalyst is present in the coating solution in an amount ranging from about 4×10⁻⁶ to 2.5×10⁻⁵ percent by weight of the coating solution. In one embodiment, the catalyst is present in the coating solution in an amount ranging from about 5×10⁻⁶ to 2×10⁻⁵ percent by weight of the coating solution. In one embodiment, the catalyst is present in the coating solution in an amount ranging from about 6×10⁻⁶ to 1.7×10⁻⁵ percent by weight of the coating solution.

In another embodiment, the coating solution further comprises a curing agent. After the film dries on the zinc-containing substrate, the article may be cured. Curing, however, can take place without a curing agent and can be concurrent with drying. Curing agents are well known to those skilled in the art and the amount of curing agent can be readily determined by one of ordinary skill in the art. Representative curing agents useful in the methods and compositions of the invention include, but are not limited to, formaldehyde resins and melamine formaldehyde resins.

In another embodiment, a pigment or dye is included in the coating solution in order to give the coated zinc containing substrate a specific decorative color. The pigment may need to be milled before the pigment is added to the coating solution. The milling may be performed using a ball roll mill or other conventional method to reduce the particle size of the pigment so that the particles may be dissolved in the coating solution. A filter may also be used to provide the appropriate pigment particle size. Depending on the particular dye or pigment being used, the concentration of the pigment or dye in the coating solution can vary over a fairly wide range. One of ordinary skill in the art, however, would readily know how much dye or pigment to add for a desired color. Typically, the dye or pigment, if present, is present in the coating solution in an amount ranging from about 1 to 40 percent by weight of the coating solution, preferably about 2 to 35 percent by weight of the coating solution. In one embodiment, the dye or pigment, if present, is present in the coating solution in an amount ranging from about 1 to 10 percent by weight of the coating solution. In one embodiment, the dye or pigment, if present, is present in the coating solution in an amount ranging from about 10 to 40 percent by weight of the coating solution. In one embodiment, the dye or pigment, if present, is present in the coating solution in an amount ranging from about 10 to 25 percent by weight of the coating solution. In one embodiment, the dye or pigment, if present, is present in the coating composition in an amount of at least about 1 parts by weight of the coating composition. In one embodiment, the dye or pigment, if present, is present in the coating composition in an amount of at least about 5 parts by weight of the coating composition. In one embodiment, the dye or pigment, if present, is present in the coating composition in an amount of at least about 10 parts by weight of the coating composition. In one embodiment, the dye or pigment, if present, is present in the coating composition in an amount of at least about 20 parts by weight of the coating composition.

The end result of the process is a zinc-containing substrate coated with a film that is chemically grafted to the zinc-containing substrate. As discussed above, chemical grafting chemically bonds the film to the zinc-containing substrate. Without being bound by theory, it is believed that in the presence of ambient moisture there are formed, on the surface of the zinc-containing substrate, a layer of oxide and hydroxyl groups bound to zinc atoms (i.e., zinc oxide and zinc hydroxide molecules). These oxides and hydroxyl groups when contacted with the graft initiator form a highly reactive radical that reacts with the alkenyl monomers and/or pre-polymers to start a polymerization reaction, which eventually forms the film.

Without wishing to be bound by theory, it is believed that the mechanism of graft polymerization can be represented as the following reaction scheme, where GI represents the graft initiator, ZnO represents an oxide bound to a zinc atom, ZnOH represents a hydroxyl bound to a zinc atom, and ZnO⁻ represents the highly reactive radical on the surface of the zinc-containing substrate:

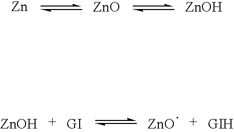

The radical ZnO⁻ then reacts with the alkenyl monomer (or with the double bond of the pre-polymer) as depicted below for the representative alkenyl monomer CH₂═CH—CH₂—X (i.e., A). 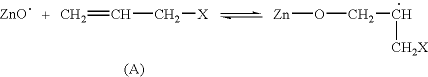
the resulting product of the reaction then continues to react in chain propagating steps with other molecules of the alkenyl monomer or pre-polymer as depicted below for reaction with another molecule of alkenyl monomer:

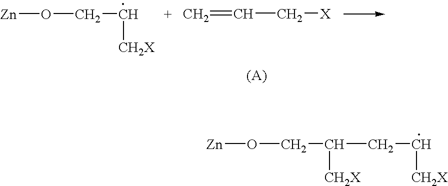

The final result is a polymer chemically bonded to the surface of the zinc containing substrate, wherein the polymer comprises the alkenyl monomer and the pre-polymer. Without wishing to be bound by theory, it is believed that the polymer chemically bonded to the surface of the zinc containing substrate can be illustrated by the formula Zn—O-(A)ₙ(B)ₘ-H, wherein A and B represent the alkenyl monomer and the pre-polymer, respectively, and n and m are integers. Importantly, the alkenyl monomer and the pre-polymer are not bonded together in any specific order. The functional groups X on the alkenyl monomer and pre-polymer are capable of cross-linking different polymer chains or providing branching in the polymer chains.

Because of its surface chemistry, however, zinc is especially difficult to chemically graft. Silver ion graft initiators, however, preferably silver perchlorate, are particularly good at forming the highly reactive radical from the oxides and hydroxyl groups on the surface of the zinc-containing substrate. Thus, silver ion graft initiators are preferred.

The alkenyl monomers and pre-polymers useful in the compositions and methods of the invention are selected based on their ability to chemically bond to zinc. Because of the chemical and physical nature of zinc, the alkenyl monomers and pre-polymers are preferably small in size, i.e., they have the molecular weight ranges described above, so that grafting can take place to most effectively coat the zinc-containing substrate.

Chemical grafting can be visualized as the growth of whiskers on a substrate. Conventionally, however, the formation of whiskers on zinc has been discouraged. This is because as whiskers grow, there is the enhanced probability that the whiskers will break off and contaminate surrounding equipment. Indeed, U.S. Pat. No. 5,730,851 describes a method to reduce and prevent whiskers on zinc. The alkenyl monomers and pre-polymers used in the compositions and methods of the invention, however, are durable. Hence, the likelihood of whiskers in the present invention breaking off and contaminating surrounding equipment is reduced.

Various coatings have been grafted onto different substrates. U.S. Pat. No. 5,429,969 describes a reactive coating of polymers and monomers on wood. Other patents, such as U.S. Pat. Nos. 4,105,811 and 5,013,266, describe grafting polymerized coatings onto metals such as aluminum and steel. See also, U.S. Pat. No. 6,414,048. These patents, however, do not recognize the performance or appearance that can be obtained on a zinc-containing substrate with the compositions and methods of the invention. In particular, the compositions and methods of the invention, which provide a chemically bonded film on the zinc-containing substrate, have a high degree of protection from corrosion, abrasion, and humidity and have a decorative appearance. The film forms a corrosion resistant film that is resistant to cracking or other failures that would expose the zinc-containing substrate to environmental conditions. The film protects the zinc-containing substrate from abrasion caused by grit or sand, chemical penetration, and scratching. The film obtained using the compositions and methods of the invention is also capable of providing a multitude of appearances to the zinc-containing substrate such as color, shine, and reflectiveness. Specific decorative appearance, such as brass, chrome, and other colors can be obtained with the compositions and methods of the invention. Moreover, the finish can be applied in one step, and the expense and hazards associated with the conventional coatings are greatly reduced.

In one embodiment, the alkenyl monomers and pre-polymers are selected so that the resultant film has a permeability to oxygen or other corrosive gases and/or a water transmission that exceeds industry accepted guidelines.

The film coated zinc-containing substrates can be used in applications such as door and faucet hardware, which are subject to impact, wear and tear, contact with perspiration from human skin, and other environmental conditions. The articles may also be used in conjunction with other pieces of equipment. The Builders Hardware Manufactures Association (BHMA), the American Society of Mechanical Engineers (ASME), the American Society for Testing and Materials (ASTM) and the International Association of Plumbing and Mechanical Officials (IAPMO) set forth industry accepted performance guidelines for items in the plumbing, building, and lock hardware industries. These guidelines are incorporated by reference.

In order to ensure that the finished product will withstand the consumer environment, the film typically meets or exceeds the finish performances listed below in Table 1. In one embodiment, the film exceeds the minimum performances required by the testing described in Table 1.

TABLE 1
FINISH PERFORMANCE TESTS

| | | | |
|---|---|---|---|
| | | | SPECIFIC |
| | | | REFERENCE FOR |
| | | INDUSTRY | REQUIRED MINIMUM |
| PROPERTY TESTING | FINISH | STANDARD | FINISH |
| STANDARD | PERFORMANCE | (BHMA/IAPMO) | PERFORMANCE |

Corrosion:

| | | | |
|---|---|---|---|
| ASTM B117-95 | 1000 hrs | 96 hrs | BHMA A156.18 (section |
| | | | 3.2) |
| ASTM B368-85 | 96 hrs | 96 hrs | BHMA A156.18 (section |
| | | | 3.9) |

Humidity:

| | | | |
|---|---|---|---|
| BHMA A156.18 (section | 1000 | 240 hrs | BHMA (A.156.18 (section |
| 3.3) | | | 3.3) |

Pencil Hardness:

| | | | |
|---|---|---|---|
| BHMA A156.18 (section | 6 H | 4 H | BHMA A156.18 (section |
| 3.4) | | | 3.4) |

Abrasion Resistance:

| | | | |
|---|---|---|---|
| ASTM D4060-95 (Taber) | 1000 cycles | 500 cycles | BHMA A156.18 (section |
| | | | 3.8) |
| ASTM D968-93 (Method | Method A-12 L of | Method A-12 L of | BHMA A156.18 (section |
| A) | silica sand on flat | silica sand on flat | 3.6) |
| | surface of specimen | surface of specimen | BHMA A112.18.1 |
| | | | (section 4.2.3.5) |

UV/Condensation:

| | | | |
|---|---|---|---|
| ASTM G53-96 | 500 hrs | 144 hrs | BHMA A156.18 (section |
| | | | 3.7) |

Perspiration Test:

| | | | |
|---|---|---|---|
| BHMA A156.18 (section | 4 cycles | 4 cycles | BHMA A156.18 (section |
| 3.5) | | | 3.5) |

Water Degradation:

| | | | |
|---|---|---|---|
| ASME A112.18.1 | Examined as stated | Examined as stated | ASME A112.18.1 (section |
| | in standard | in standard | 4.2.3.2) |

Adhesion:

| | | | |
|---|---|---|---|
| ASTM D3359-02 (Method | Examined as stated | Examined as stated | ASME A112.18.1-3 |
| A) | in standard | in standard | (section 4.2.3.4) |
| ASTM B571-97e1 | Examined as stated | Examined as stated | ASME A112.18.1 (section |
| | in standard | in standard | 4.2.1-b) |

Soap and Cleaner Effects:

| | | | |
|---|---|---|---|
| ASME A112.18.1 | Examined as stated | Examined as stated | ASME A112.18.1 (section |
| | in standard | in standard | 4.2.3.3) |

Materials are subjected to harsh testing just to meet the minimum requirements of these industry standards. For example, the corrosion resistance test ASTM B117-95 subjects an item to 96 hours of a salt spray and afterwards the item must not have more than one spot of corrosion greater than 1.6 mm in diameter. The film formed on the zinc-coated substrate by the compositions and methods of the present invention, however, can be subject to the corrosive environment of corrosion resistance test ASTM B117-95 for a period of time much longer than 96 hours and still meet the required performance.

For illustrative purposes only, the following examples set forth coatings that may be contacted with the zinc-containing substrate to produce a film with enhanced protective properties and that give the substrate a specific decorative color. The names of commercial products are used for illustrative purposes only and are not intended to limit the scope of the invention.

### EXAMPLES

EXAMPLE 1
BRIGHT CHROME

| | PARTS BY | PERCENT BY |
|---|---|---|
| INGREDIENT | WEIGHT | WEIGHT |
| Silicone polyester pre-polymer | 60.00 | 66.0 |
| Chempol 206-9460 | | |
| Cellosolve acetate 92.0 | 8.00 | 8.8 |
| N butanol 8.0 | | |
| Methyl ethyl ketone (MEK) | 20.00 | 22.0 |
| Coatosil 3573 | 0.30 | 0.33 |
| Monomer silane A174 (Silquest A174) | 1.00 | 1.1 |
| Zapon blue 807 (10% in MEK) | 1.00 | 1.1 |
| Brilliant violet S-3RL (10% MEK) | 0.20 | 0.22 |
| Silver perchlorate (0.1% in MEK) | 0.10 | 0.11 |
| Methyl ethyl ketone peroxide | 0.05 | 0.06 |

EXAMPLE 2
BRIGHT CHROME

| | PARTS BY | PERCENT BY |
|---|---|---|
| INGREDIENT | WEIGHT | WEIGHT |
| Silicone polyester pre-polymer | 4.20 | 3.2 |
| Chempol 206-9460 | | |
| Polyester pre-polymer | 0.14 | 0.11 |
| Chempol 011-2339 | | |
| Cellosolve acetate 92.0 | 0.70 | 0.54 |
| N butanol 8.0 | | |
| Methyl ethyl ketone | 70.00 | 53.9 |
| PM acetate | 24.00 | 18.5 |
| Pigment Metalure L55700 | 25.00 | 19.3 |
| Monomer silane A174 (Silquest A174) | 6.06 | 4.7 |
| Coatosil 1211 | 0.10 | 0.08 |
| Benzoyl peroxide (0.01% in MEK) | 0.10 | 0.08 |
| Silver perchlorate (0.1% in MEK) | 0.10 | 0.08 |

EXAMPLE 3
ALUMINUM GRAY

| | PARTS BY | PERCENT BY |
|---|---|---|
| INGREDIENT | WEIGHT | WEIGHT |
| Alkyd ester pre-polymer | 27.00 | 40.4 |
| Kelsol 3964 B26-70 | | |
| Butyl cellusolve | 23.50 | 34.8 |
| PM solvent | 3.00 | 4.4 |
| Melamine pre-polymer Cymel 303 | 6.00 | 8.9 |
| Eternabrite EBP251PA | 6.00 | 8.9 |
| Sartomer 252 | 1.00 | 1.5 |
| Monomer silane A187 (Silquest A174) | 1.00 | 1.5 |
| Benzoyl peroxide (0.01% in MEK) | 0.10 | 0.15 |
| Silver perchlorate (0.1% in MEK) | 0.10 | 0.15 |

EXAMPLE 4
YELLOW

| | PARTS BY | PERCENT BY |
|---|---|---|
| INGREDIENTS | WEIGHT | WEIGHT |
| Silicone polyester pre-polymer | 60.00 | 42.6 |
| Chempol 206-9460 8.0 | | |
| Cellosolve acetate 92.0 | 8.50 | 6.0 |
| N-Butanol 8.0 | | |
| Polyester pre-polymer Chempol | 2.50 | 1.8 |
| 011-2339 | | |
| PM acetate | 31.50 | 22.4 |
| Monomer silane A174 (Silquest A174) | 1.00 | 0.71 |
| Coatosil 3573 | 0.30 | 0.21 |
| Methyl ethyl ketone | 21.70 | 15.4 |
| Neozapon yellow 115 (8% in MEK) | 5.00 | 3.6 |
| Neozapon red 365 (2% in MEK) | 11.00 | 7.8 |
| Methyl ethyl ketone peroxide (0.1% | 0.10 | 0.07 |
| in MEK) | | |
| Silver perchlorate (0.1% in MEK) | 0.10 | 0.07 |

EXAMPLE 5
GOLD

| | PARTS BY | PERCENT BY |
|---|---|---|
| INGREDIENTS | WEIGHT | WEIGHT |
| Silicone polyester pre-polymer | 60.00 | 38.4 |
| Chempol 206-9460 | | |
| PM acetate | 65.00 | 41.6 |
| Polyester pre-polymer | 2.50 | 1.6 |
| Chempol 011-2339 | | |
| Monomer silane A174 (Silquest A174) | 1.00 | 0.64 |
| Coatosil 3573 | 0.30 | 0.19 |
| Coatosil 1211 | 0.30 | 0.19 |
| Methyl Ethyl Ketone | 5.00 | 3.2 |
| Zapon yellow 141 (2.5% in MEK) | 15.00 | 9.6 |
| Sudan orange 220 (5% in MEK) | 1.00 | 0.64 |
| Neozapon red 365 (2% in MEK) | 5.00 | 3.2 |
| Benzoyl peroxide (0.01% in MEK) | 0.10 | 0.06 |
| Silver perchlorate (0.1% in MEK) | 0.10 | 0.06 |

EXAMPLE 6
CLEAR (or CHROME) FINISH

| INGREDIENTS | PARTS BY WEIGHT |
|---|---|
| Chempol 206-B489-074 | 65 |
| Methyl amyl ketone | 28 to 33 |
| Silane A-174 (Silquest A174) | 0.9 |
| Coatosil 1211 | 0.3 |
| Coatosil 3573 | 0.3 |
| Benzoyl peroxide (0.01% in MEK) | 0.1 |
| Silver perchlorate (0.01% in MEK) | 0.1 |
| Amorphous silicon dioxide (for satin | 2 |
| chrome finish) | |

The present invention is not to be limited in scope by the specific embodiments disclosed in the examples which are intended as illustrations of a few aspects of the invention and any embodiments that are functionally equivalent are within the scope of this invention. Indeed, various modifications of the invention in addition to those shown and described herein will become apparent to those skilled in the art and are intended to fall within the scope of the appended claims.

A number of references have been cited, the entire disclosure of which are incorporated herein by reference.

What is claimed is:

1. A composition comprising:
(i) an alkenyl monomer;
(ii) a pre-polymer; and
(iii) a graft initiator,
wherein applying the composition to a zinc containing substrate provides a film on the zinc-containing substrate that is chemically grafted to the zinc-containing substrate.

2. The composition of claim 1, wherein the graft initiator comprises silver ions.

3. The composition of claim 1, wherein the graft initiator is silver perchlorate.

4. A coating solution comprising the composition of claim 1 and a solvent.

5. The coating solution of claim 4, wherein the alkenyl monomer is present in an amount ranging from about 0.2 to 6.3 parts by weight of the coating solution.

6. The coating solution of claim 5, wherein the pre-polymer is present in an amount ranging from about 4.6 to 70 percent by weight of the coating solution.

7. The coating solution of claim 5, wherein the graft initiator is present in an amount ranging from about 0.5×10⁻⁵ to 3×10⁻⁴ percent by weight of the coating solution.

8. The coating solution of claim 5, further comprising a dye or pigment

9. The coating solution of claim 5, further comprising a curing agent.

10. The coating solution of claim 5, further comprising a peroxide catalyst.

11. The coating solution of claim 10, wherein the peroxide catalyst is benzoyl peroxide.

12. A coating solution comprising:
60.00 parts by weight silicone polyester pre-polymer Chempol 206-94;
65.00 parts by weight PM Acetate;
2.50 parts by weight polyester pre-polymer Chempol 011-2339;
1.00 parts by weight Sulquest A174;
0.30 parts by weight Coatosil 3573;
0.30 parts by weight Coatosil 1211;
5.00 parts by weight methyl ethyl ketone;
15.00 parts by weight zapon yellow 141 (2.5% in MEK);
1.00 parts by weight sudan orange 220 (5% in MEK);
5.00 parts by weight neozapon red 365 (2% in MEK);
0.10 parts by weight benzoyl peroxide (0.01% in MEK); and
0.10 silver perchlorate (0.1% in MEK).

13. A coating solution comprising:
4.20 parts by weight silicone polyester pre-polymer Chempol 206-9460;
0.14 parts by weight polyester pre-polymer Chempol 011-2339;
0.70 parts by weight cellosolve acetate 92.0 and N butanol 8.0;
70.00 parts by weight methyl ethyl ketone;
24.00 parts by weight PM acetate;
25.00 parts by weight pigment Metalure L55700;
6.06 parts by weight Sitquest A174,
0.10 Coatosil 1211;
0.10 benzoyol peroxide (0.01% in MEK); and
0.10 silver perchlorate (0.1% in MEK).

14. A coating solution comprising:
65 parts by weight of Chempol 206-B489-074;
28 to 33 parts by weight of methyl amyl ketone;
0.9 parts by weight of Silquest A-174;
0.3 parts by weight of Coatosil 1211;
parts by weight of Coatosil 3573;
0.1 parts by weight of benzoyl peroxide (0.01% in MEK);
0.1 parts by weight of silver perchlorate (0.01% in MEK); and
optionally 2 parts by weight of amorphous silicon dioxide.

15. A method for forming a film on a zinc-containing substrate comprising:
(a) providing a zinc-containing substrate;
(b) providing a coating solution comprising
(i) an alkenyl monomer;
(ii) a pre-polymer; and
(iii) a graft initiator, and
(c) contacting the zinc-containing substrate with the coating solution
wherein applying the composition to the zinc containing substrate provides a film on the zinc-containing substrate that is chemically grafted to the zinc-containing substrate.

16. The method of claim 15 further, comprising drying the coating solution after it is contacted with the zinc-containing substrate.

17. An article of manufacture comprising:
a zinc-containing substrate and a film chemically bonded to the zinc-containing substrate, wherein the film is formed by contacting the zinc-containing substrate with a coating solution comprising
(i) an alkenyl monomer;
(ii) a pre-polymer; and
(iii) a graft initiator.

18. The article of claim 17, wherein the article of manufacture has the appearance of chrome, satin chrome, or brass.

19. The article of claim 17, wherein the film has at least one of (a) a corrosion resistance that meets at least 1000 hrs of ASTM B117-95 or (b) an abrasion resistance that meets at least 1000 cycles of ASTM D4060-95 (Taber).

20. The article of claim 19, wherein the film has both (a) a corrosion resistance that meets at least 1000 hrs of ASTM B117-95 and (b) an abrasion resistance that meets at least 1000 cycles of ASTM D4060-95 (Taber).
